(19) United States
(12) Patent Application Publication
(10) Pub. No.: US 2020/0395892 A1
(43) Pub. Date: Dec. 17, 2020

(54) SOILING DETECTION APPARATUS AND METHOD

(71) Applicant: Dubai Electricity & Water Authority, Dubai (AE)

(72) Inventor: Ammar Mohammed Munir Sulayman Alsabounchi, Dubai (AE)

(21) Appl. No.: 16/970,913

(22) PCT Filed: Apr. 9, 2018
(86) PCT No.: PCT/IB2018/052444

§ 371 Date: Aug. 18, 2020

(30) Foreign Application Priority Data
Feb. 19, 2018 (AE) P6000263/2018

(51) Int. Cl. H02S 50/15; H02S 10/00; H02S 40/10

(52) U.S. Cl. CPC H02S 50/15; H02S 40/10; H02S 10/00

(57) ABSTRACT

A soiling detection apparatus operable to detect a soiling level of a photovoltaic panel. The apparatus comprising a photovoltaic panel operable to generate an electrical output in response to light being incident on the panel and in dependence upon a soiling level of the photovoltaic panel. The apparatus comprises a pyranometer operable to generate an irradiance signal which relates to an irradiance level of light incident on the pyranometer. The pyranometer is positioned with respect to the photovoltaic panel such that the photovoltaic panel and the pyranometer can receive substantially the same solar radiation level as each other. The apparatus comprises calculating means operable to calculate a reference output value from the irradiance signal which relates to an ideal electrical output of the photovoltaic panel at a predetermined operating condition. The apparatus further comprises measuring means operable to measure the electrical output of the photovoltaic panel at the predetermined operating condition, and comparing means operable to compare the measured electrical output of the photovoltaic panel at the predetermined operating condition with the reference output value so as to generate a comparison value. The apparatus comprises outputting means operable to output a cleaning signal when the comparison value is greater than a cleaning threshold value.

The present disclosure relates to a soiling detection apparatus and method.

Solar Photovoltaic (PV) installations in arid and desert areas are potentially affected by frequent soiling caused by precipitation of suspended dust, sand, and other airborne particles on the surface of PV panels. The impact becomes even worse in humid weather where the particles stick accumulatively on PV surfaces forming a thick and substantially opaque layer of soiling. The situation turns out to be a serious issue that declines the efficiency of PV plant and, consequently, its profitability.

As such, PV plant operators may run regular cleaning events for PV panels on a prescheduled frequency, such as monthly or biweekly. However, the actual need for cleaning events is likely to change, for example based on changes in weather conditions. This may adversely affect the optimal operation of the prescheduled cleaning events. For example, a cleaning event may occur or be scheduled when the panels do not need cleaning, or may occur after when the panel may actually need cleaning.

One way that this issue may be addressed is to detect a soiling level of the PV panels. A cleaning event may then be arranged for when the panel needs cleaning, such as a soiling level reaching a certain soiling threshold. One arrangement to detect the soiling level is to install two PV modules. A first PV module comprising a first PV panel is positioned to be exposed to substantially the same soiling conditions as those experienced by a photovoltaic plant, such as one comprising a plurality of PV modules. A second PV module comprising a second PV panel that is substantially analogous to the first PV module is positioned to receive substantially the same solar radiation as the first PV module. The second PV module is intended to be maintained in a clean state such that soiling should not substantially affect its output. The output of the first PV module and the second PV module may then be compared to estimate the soiling level.

However, in order to keep the second PV module clean, regular and frequent cleaning events may be needed. Alternatively, some arrangements use a cover to protect the surface of the second PV from soiling deposits that may be removed automatically or manually when a soiling measurement is to be performed. However, such arrangements can be costly, mechanically complex, and prone to malfunction.

Examples of the present disclosure seek to address or at least alleviate the above problems.

In a first aspect, there is provided a soiling detection apparatus operable to detect a soiling level of a photovoltaic panel, the apparatus comprising: a photovoltaic panel operable to generate an electrical output in response to light being incident on the panel and in dependence upon a soiling level of the photovoltaic panel; a pyranometer operable to generate an irradiance signal which relates to an irradiance level of light incident on the pyranometer, the pyranometer being positioned with respect to the photovoltaic panel such that the photovoltaic panel and the pyranometer can receive substantially the same solar radiation level as each other; calculating means operable to calculate a reference output value from the irradiance signal which relates to an ideal electrical output of the photovoltaic panel at a predetermined operating condition; measuring means operable to measure the electrical output of the photovoltaic panel at the predetermined operating condition; comparing means operable to compare the measured electrical output of the photovoltaic panel at the predetermined operating condition with the reference output value so as to generate a comparison value; and outputting means operable to output a cleaning signal when the comparison value is greater than a cleaning threshold value.

In a second aspect there is provided a soiling detection method for detecting a soiling level of a photovoltaic panel using a soiling detection apparatus comprising a photovoltaic panel and a pyranometer positioned with respect to the photovoltaic panel such that the photovoltaic panel and the pyranometer can receive substantially the same solar radiation level as each other, the method comprising: generating, by the photovoltaic panel, an electrical output in response to light being incident on the panel and in dependence upon a soiling level of the photovoltaic panel; generating, by the pyranometer, an irradiance signal which relates to an irradiance level of light incident on the pyranometer; calculating a reference output value from the irradiance signal which relates to an ideal electrical output of the photovoltaic panel at a predetermined operating condition; measuring the electrical output of the photovoltaic panel at the predetermined operating condition; comparing the measured electrical output of the photovoltaic panel at the predetermined operating condition with the reference output value so as to generate a comparison value; and outputting a cleaning signal when the comparison value is greater than a cleaning threshold value.

Other aspects and features are defined in the appended claims.

Examples of the disclosure may use a photovoltaic panel and a pyranometer to detect a soiling level. By using one photovoltaic panel for example, costs may be reduced and flexibility and reliability of measurement may be improved. Additionally, examples of the disclosure may help reduce the need for cleaning or a requirement to use a mechanism to keep a reference PV panel clean in order for the soiling detection to take place. For example, a need for cleaning of the PV panel of examples of the disclosure may be reduced because an expected output that may correspond to that which may occur for a substantially clean PV panel may be predicted from the reference output value calculated from the irradiance as measured by the pyranometer.

For example, by comparing the measured electrical output of the PV panel with the reference output value based on the irradiance signal generated by the pyranometer, an indication of the level of soiling may be obtained. If, for example, the comparison value is greater than the cleaning threshold value, then the cleaning signal is output. For example, the cleaning signal may indicate that the PV panel, and hence other PV panels in a PV plant where the apparatus is located may need cleaning. Therefore, for example, a cleaning event may be scheduled as appropriate depending on the detected level of soiling and thus the efficiency of cleaning events may be improved, whilst a need for cleaning a reference PV panel may be reduced or removed. Additionally, examples of the disclosure may allow a suitability of a location for a proposed PV plant to be determined more easily, for example based on the measured level of soiling at that location.

Examples of the disclosure will now be described by way of example only with reference to the accompanying drawings, in which like references refer to like parts, and in which:

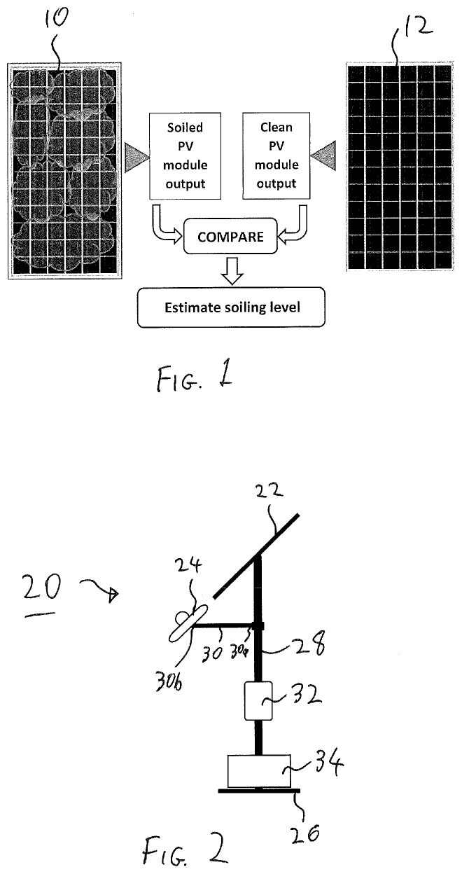

FIG. 1 is a schematic representation of an arrangement for measuring soiling using two photovoltaic panels;

FIG. 2 is a schematic representation of a soiling detection apparatus according to examples of the disclosure;

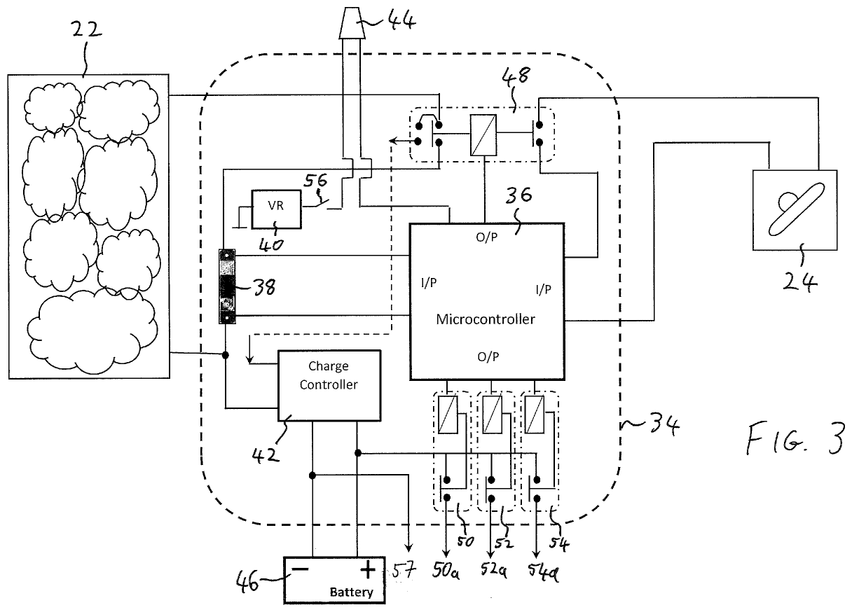

FIG. 3 is a schematic circuit diagram of the soiling detection apparatus according to examples of the disclosure;

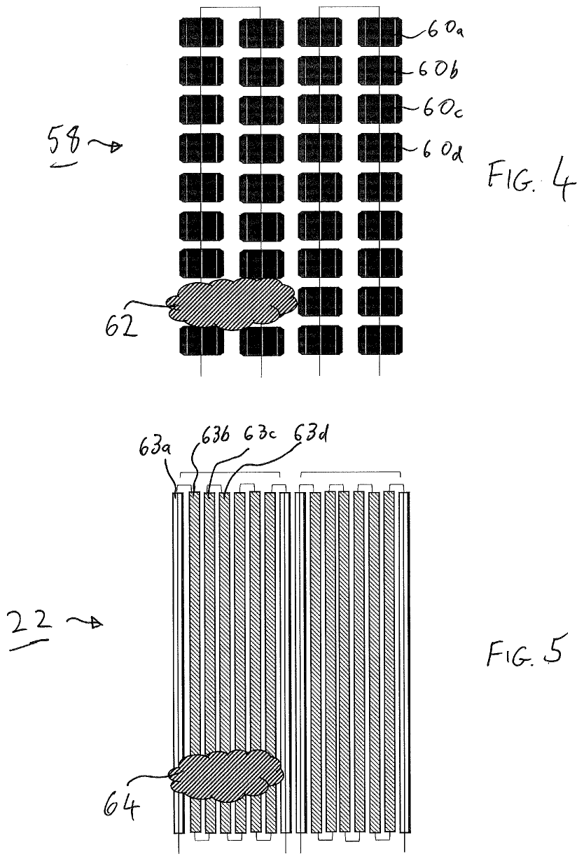

FIG. 4 is a schematic representation of soiling of a crystalline silicon photovoltaic panel;

FIG. 5 is a schematic representation of soiling of a thin-film photovoltaic panel;

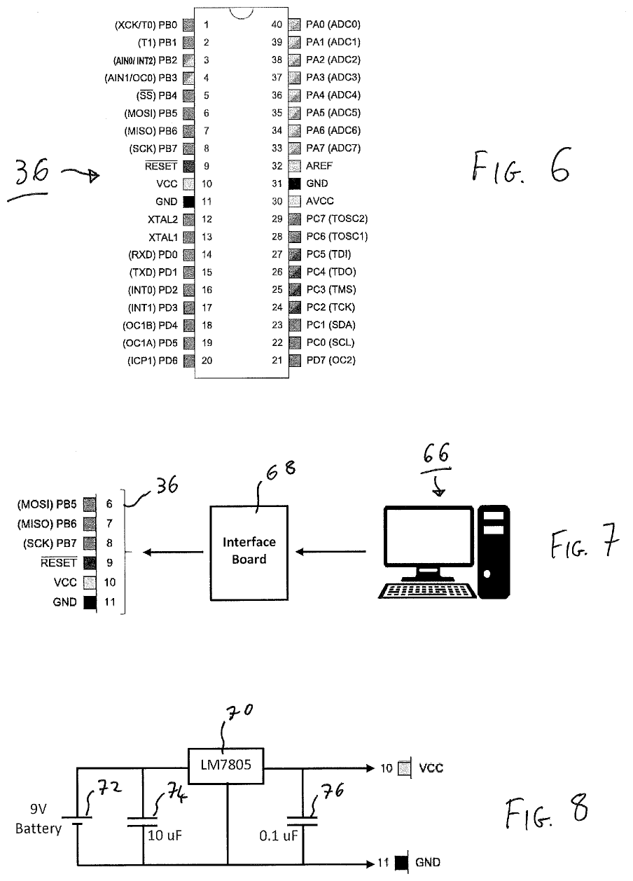

FIG. 6 is a schematic pin layout diagram of a microcontroller used in the soiling detection apparatus according to examples of the disclosure;

FIG. 7 is a schematic representation of apparatus for programming the microcontroller of the soiling detection apparatus according to examples of the disclosure;

FIG. 8 is a schematic circuit diagram of a voltage regulation circuit for providing electrical power to the microcontroller according to examples of the disclosure;

FIG. 9 is a schematic pin layout diagram of a voltage regulator used in the soiling detection apparatus according to examples of the disclosure;

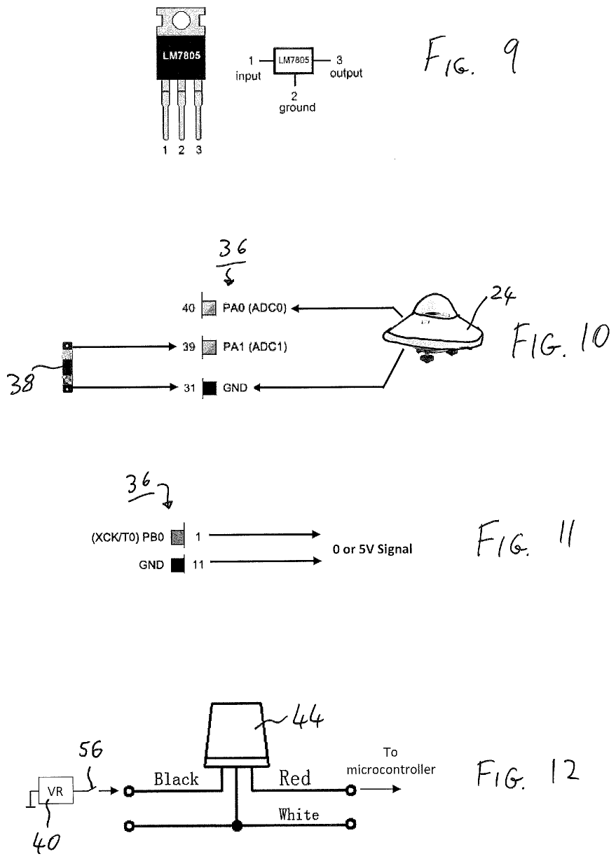

FIG. 10 is a schematic diagram of a connection layout of a pyranometer and a shunt resistor used in the soiling detection apparatus according to examples of the disclosure;

FIG. 11 is a schematic diagram of an output signal path from the microcontroller used in the soiling detection apparatus according to examples of the disclosure;

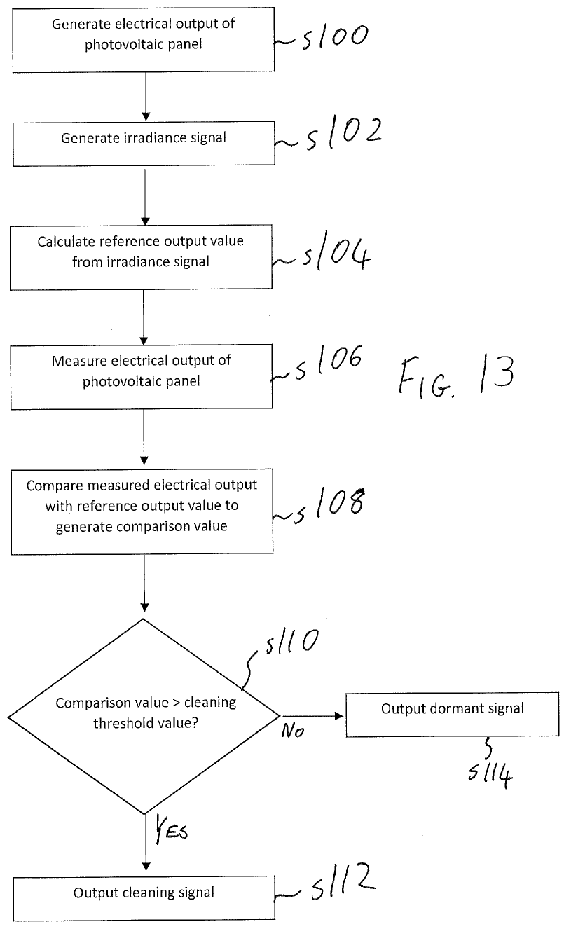

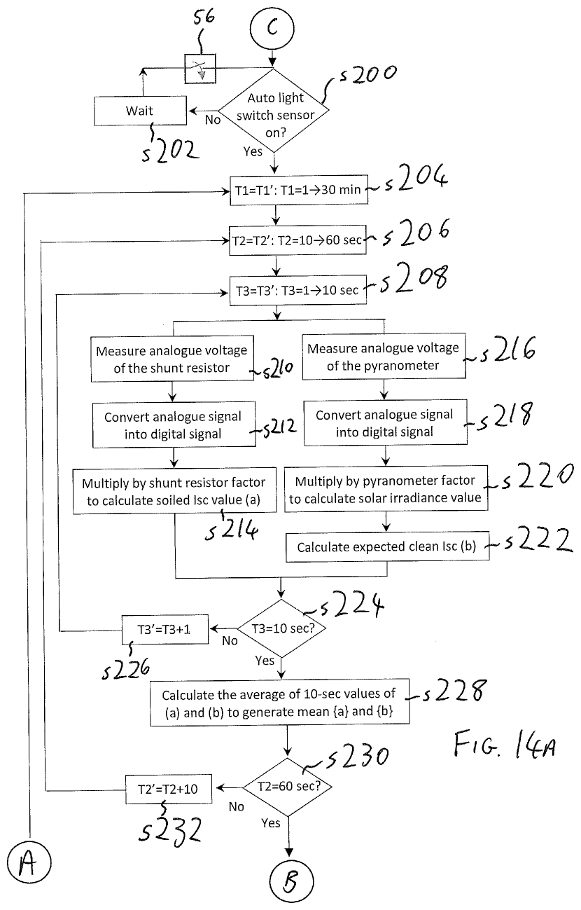

FIG. 12 is a schematic circuit diagram of connection of the voltage regulation circuit to a light sensor used in the soiling detection apparatus according to examples of the disclosure;

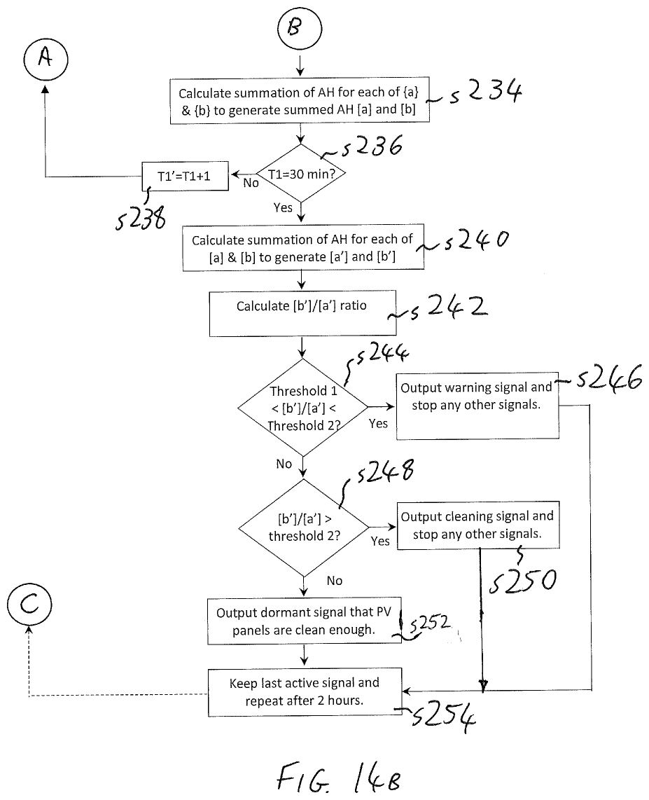

FIG. 13 is a flow chart of a method for detecting a soiling level of a photovoltaic panel using a soiling detection apparatus according to examples of the disclosure; and

FIGS. 14A and 14B are a flowchart of a method for detecting a soiling level of a photovoltaic panel by measuring the voltage across the shunt resistor according to examples of the disclosure.

A soiling detection apparatus and soiling detection method is disclosed. In the following description, a number of specific details are presented in order to provide a thorough understanding of the examples of the disclosure. It will be apparent however to a person skilled in the art that these specific details need not be employed in order to practise the examples of the disclosure. Conversely, specific details known to the person skilled in the art are omitted for the purposes of clarity in presenting the examples.

FIG. 1 is a schematic representation of an arrangement for measuring soiling using two photovoltaic panels. As mentioned above, a previous arrangement for detecting soiling may use two photovoltaic panels to detect a soiling level. The previous arrangement comprises a first photovoltaic module 10 and a second photovoltaic module 12. The first PV module 10 comprises a first PV panel, and the second PV module 12 comprises a second PV panel. The first PV panel is positioned to be exposed to substantially the same soiling conditions as those experienced by a photovoltaic plant, such as one comprising a plurality of PV modules. The second PV module 12 is substantially analogous to the first PV module 10 and is positioned to receive substantially the same solar radiation as the first PV module 10. The second PV module 12 is intended to be maintained in a clean state such that soiling should not substantially effect its output. The output of the first PV module 10 and the second PV module 12 may then be compared to estimate the soiling level. However, as mentioned above, in order to keep the second PV module clean, regular and frequent cleaning events may be needed. Alternatively, some arrangements use a cover to protect the surface of the second PV from soiling deposits that may be removed automatically or manually when a soiling measurement is to be performed. However, such arrangements can be costly, mechanically complex, and prone to malfunction. Additionally, trying to keep a PV panel clean all the time in arid desert areas of humid climate may be a serious burden.

FIG. 2 is a schematic representation of a soiling detection apparatus 20 according to examples of the disclosure. In examples, the soiling detection apparatus 20 operable to detect a soiling level of a photovoltaic panel. In examples, the apparatus comprises a photovoltaic panel 22 operable to generate an electrical output in response to light being incident on the panel 22 and in dependence upon a soiling level of the photovoltaic panel 22. In examples, the PV panel 22 is a thin film PV panel. In examples, the PV panel 22 is a thin-film CdTe PV panel, model manufactured by First Solar. However, it will be appreciated that other types of PV panel could be used such as a polycrystalline silicon panel.

In examples, the apparatus also comprises a pyranometer 24 operable to generate an irradiance signal which relates to an irradiance level of light incident on the pyranometer 24. Pyranometers are typically used to measure solar irradiance. Typical pyranometers comprise a white metallic housing, that comprises a hemispherical glass dome under which a black metal absorber is positioned so that it can be heated by solar irradiance incident on the dome. Typically thermopile pyranometers comprise a thermocouple and the difference temperature between the absorber and the metallic housing is measured so as to generate a voltage. The voltage is generally proportional to the solar irradiance value. In other words for example, the pyranometer may generally operate by measurement of a heat difference. Therefore, the pyranometer may be less likely to need frequent cleaning such as may occur in the case where an irradiance detector comprising a PV reference cell is used.

In examples, the pyranometer 24 comprises a pyranometer model number CMP10 produced by KIPP & ZONEN with a typical output voltage in the range 0-1 V. More generally, in examples, the pyranometer comprises a thermopile pyranometer. However, it will be appreciated that other suitable pyranometers may be used.

In examples, the pyranometer 24 is positioned with respect to the photovoltaic panel 22 such that the photovoltaic panel 22 and the pyranometer 24 can receive substantially the same solar radiation level as each other. For example, the PV panel 22 and pyranometer 24 may have substantially the same angle and orientation as each other, and be positioned so that they do not occlude each other from solar radiation when the soiling detection apparatus 20 is deployed at a suitable site.

In examples, the apparatus 20 comprises a base and a support pole 28 mounted on the base so as to be able to support the PV panel 22 and the pyranometer 24. In examples, the PV panel 22 is mounted on top of the support pole 28. In examples, the support pole comprises a pole manufactured by Xiamen Sunforson Power Co., Ltd, model number SFS-P-60. In examples, the PV panel 22 is mounted to the pole 28 using a PV holder, for example as manufactured by Xiamen Sunforson Power Co., Ltd, model number SFS-MD-01. However, it will be appreciated that other suitable support poles and PV holders could be used.

In examples, the apparatus 20 comprises an arm 30 that is mounted to the support pole 28 at a first end 30a of the arm 30 so as to extend away from the support pole 30. In examples, the pyranometer 24 is mounted on a second end 30b of the arm 30 so as to have substantially the same angle and orientation as the PV panel 22.

In examples, the apparatus 20 comprises a circuitry enclosure 32 mounted on the support pole 28 between the base 26 and the PV panel 22. In examples, the circuitry enclosure 32 houses circuitry for measuring a soiling level of the PV panel 22 as will be described in more detail below. In examples, the circuitry enclosure 32 comprises an enclosure manufactured by Zhejiang B&J Electrical Co., Ltd. model number 2520/150, and has IP66 environmental protection level. In examples, the circuitry enclosure 32 has at least an environmental protection level of IP54 so as to be able to protect the circuitry from the surrounding environment and help reduce the risk of malfunction. However, it will be appreciated that other suitable enclosures could be used to house the circuitry of the apparatus 20.

In examples, the apparatus 20 comprises a battery enclosure 34 mounted on the base 26. In examples, the battery enclosure 34 houses a battery for supplying power to output signal circuitry of the apparatus 20. In examples, the battery may also be used to provide power to measuring circuitry of the apparatus 20. In examples, the battery enclosure 34 comprises a Snap-Top battery box model number HM318BKS, manufactured by NOCO®, although it will be appreciated that other suitable battery enclosures could be used. In examples, the battery enclosure 34 comprises a deep cycle valve regulated lead acid (VRLA) battery type, such as a 12V-26 Ah, model DC12-26 manufactured by RITAR. However, it will be appreciated that other batteries could be used.

In examples, the apparatus 20 can be positioned at a PV plant comprising a plurality of PV panels for generating electricity so as to receive substantially the same soiling as one or more PV panels of the PV plant. In other words, in examples, the PV plant comprises the apparatus 20. In other words, more generally in examples, the photovoltaic plant comprises a plurality of photovoltaic panels for generating electricity, and the soiling detection apparatus 20, in which the soiling detection apparatus is positioned with respect to one or more photovoltaic panels of the photovoltaic plant so as to receive substantially the same soiling as the one or more photovoltaic panels of the photovoltaic plant. The apparatus 20 may thus help provide an indication of whether the PV panels of the PV plant need cleaning.

In examples, the apparatus 20 may also be used as a standalone unit, for example to assess the suitability of a prospective site for a PV plant.

FIG. 3 is a schematic circuit diagram of the soiling detection apparatus 20 according to examples of the disclosure. In examples, the soiling detection apparatus 20 comprises a soiling detection circuit for measuring a soiling level of the PV panel 22.

In examples, the soiling detection circuitry may act as calculating means operable to calculate a reference output value from the irradiance signal which relates to an ideal electrical output of the photovoltaic panel at a predetermined operating condition. In examples, the soiling detection circuitry may act as measuring means operable to measure the electrical output of the photovoltaic panel at the predetermined operating condition. In examples, the soiling detection circuitry may act as comparing means operable to compare the measured electrical output of the photovoltaic panel at the predetermined operating condition with the reference output value so as to generate a comparison value. In examples, the soiling detection circuitry may act as outputting means operable to output a cleaning signal when the comparison value is greater than a cleaning threshold value.

For example, the soiling detection apparatus and method of the disclosure may help provide a more reliable indication of level of soiling. Furthermore, for example, a need for regular cleaning of the soiling detection apparatus or the need for complex apparatus to help maintain a reference PV panel in a clean state may be reduced, because the pyranometer may be less affected by soiling than a PV panel due to the irradiance measurement being based on a thermal measurement for example.

Thus, for example, the reference output value calculated from the irradiance signal may relate to an ideal operating condition of the PV panel 22 such as if the panel is clean. In other words for example, the reference output value relates to an expected electrical output value for the PV panel in a substantially clean state. By comparing, for example, the measured electrical output of the PV panel 22 at the predetermined operating condition with the reference output value, an indication of a level of soiling of the PV panel 22 may be obtained, for example based on the comparison value. If for example, the comparison value is greater than a cleaning threshold value, then the apparatus may output a cleaning signal. In examples, the cleaning signal indicates that the PV panel needs cleaning, although it could indicate other conditions such as estimated future time period after which the PV panel needs cleaning. In examples, the cleaning signal relates to a level of soiling of the PV panel 22. Therefore, for example, a need to run prescheduled cleaning events of inefficient frequency may also be reduced because the cleaning signal may be output when the comparison value is greater than the cleaning threshold value. Additionally, for example, the PV panel 22 may not need cleaning unless PV panels of the PV plant are cleaned. The apparatus 20 may for example also help determine if there is a malfunction of the PV plant. For example if output of the PV plant is below a malfunction threshold and the comparison value is less than the cleaning threshold value, then a PV plant malfunction signal may be output.

In examples, the soiling detection circuit comprises the PV panel 22, the pyranometer 24, a microcontroller 36, a shunt resistor 38, a voltage regulator 40, a charge controller 42, a light sensor 44, a battery 46, a first relay 48, a second relay 50, a third relay 52, a fourth relay 54 and a switch 56. In examples, the microcontroller 36, the shunt resistor 38, the voltage regulator 40, the charge controller 42, the first relay 48, the second relay 50, the third relay 52, the fourth relay 54, and the switch 56 are housed within the circuitry enclosure 32. However, it will be appreciated that other arrangements for housing one or more components of the circuitry could be used.

Operation of the soiling detection circuitry will be described in more detail later below.

In examples, the first relay 48, the second relay 50, the third relay 52 and the fourth relay 54 are operably connected to output (O/P) pins of the microcontroller 36 so as to be able to be in electrical communication with the microcontroller 36. In examples, the second relay 50, third relay 52, and fourth relay 54 are single pole, single throw relays. However, it will be appreciated that other types of relay could be used as appropriate. In examples, the second relay 50, third relay 52, and fourth relay 54 are used to provide a plurality of output signals which relate to a soiling level of the PV panel 22. In examples, the output signals comprise a first output signal 50a, a second output signal 52a, and a third output signal 54a respectively via a current path 57 from the battery 46.

In examples, the voltage regulator 40, switch 56, and light sensor 44 are operably connected to the microcontroller 36 so as to be able to provide electrical power to the microcontroller 36. In examples, the microcontroller 36 comprises an internal memory, although it will be appreciated that an external memory could be used. In examples, the PV is operably connected to input (I/P) pins of the microcontroller 36 via the shunt resistor 38 and the first relay 48 so as to be able to be in electrical communication with the microcontroller 36. In examples, the PV panel 22 is operably connected to the battery 46 via the charge controller 42 and the first relay 48 so as to be able to charge the battery 46, for example, when soiling detection is not to be performed. In examples, the pyranometer 24 is operably coupled to input pins (I/P) of the microcontroller 36 via the first relay 48 so as to be able to be in electrical communication with the microcontroller 36. In examples, the first relay 48 is a double pole, double throw relay. As previously mentioned, the operation of components of the soiling detection circuit will be described in more detail later below.

FIG. 4 is a schematic representation of soiling of a crystalline silicon photovoltaic panel, and FIG. 5 is a schematic representation of soiling of a thin-film photovoltaic panel. In particular, FIG. 4 schematically shows a crystalline silicon PV panel 58 comprising a plurality of crystalline silicon photovoltaic cells (such as PV cells 60a, 60b, 60c, and 60d). FIG. 4 schematically shows a soiling patch 62 occluding two cells. For example, it is possible that soiling or shading may block an entire area of one or more of the PV cells of the PV panel 58 such as the soiling patch 62. This may mean that any cells that are connected in series with the ones occluded by the soiling patch 62 may be invalidated. For example, such cells may generate little or no electrical current, and may be considered to be out of service totally or partially based on the level of soiling. Therefore, using crystalline silicon PV panel as a reference to detect the soiling level may give inaccurate results.

FIG. 5 schematically shows an example of the PV panel 22. As mentioned above, in examples, the PV panel 22 comprises a thin-film PV panel. In comparison to crystalline silicon PV panels, thin film PV panels typically comprise a plurality of PV cells (such as PV cells 63a, 63b, 63c, 63d) each formed as a narrow strip, for example extending along a full length of the panel from one side to the other. In other words, more generally in examples, the photovoltaic panel 22 comprises a plurality of thin film photovoltaic cells. FIG. 5 schematically shows a soiling patch 64 position in substantially at the same position with respect panel 22 as the soiling patch 62 has with respect to the crystalline silicon panel 58. In the example of FIG. 5, the soiling patch 64 has substantially the same shape and size as the soiling patch 62 illustrated in FIG. 4. However, because the cells of the PV panel 22 in examples extend substantially along a full length of the panel from one side to the other, the risk that an entire area of a cell or cells is occluded by a soiling patch, such as soiling patch 64, may be reduced. Therefore, the use of a thin-film PV panel may help improve reliability and accuracy of soiling measurements.

FIG. 6 is a schematic pin layout diagram of a microcontroller used in the soiling detection apparatus according to examples of the disclosure. In particular, FIG. 6 shows a pin layout of the microcontroller 36. In examples, the microcontroller 36 comprises an 8-bit microcontroller model Atmega32 40 Pin PDIP, produced by Atmel Corporation. However, it will be appreciated that other microcontrollers could be used. Pins 33 to 40 relate to analogue to digital converters. Pin 10 VCC, pin 11 GND and pin 31 GND may be used to provide power to the microcontroller such as from a 5 volt power source. Pin 30 AVCC may also be connected to a power supply such as a 5V power source and should be electrically connected to pin 10 VCC. Pin 13 XTAL1 and pin 12 XTAL2 may be used in respect of an internal inverting oscillator amplifier, for example for connection to an external oscilloscope for testing if required, or to act as an external clock signal for example Pin 32 AREF may be used as an analogue reference pin for ADC pins 33 to 40, and pin 9 RESET may allow the microcontroller to be reset. Pins 1-7 (PB0-PB7), pins 22-29 (PC0-PC7), and pins 14-21 (PD0-PD7) may act as 8-bit bi-directional I/O (input/output) ports for example to provide one or more output signals and/or for programming the microcontroller 36.

FIG. 7 is a schematic representation of apparatus for programming the microcontroller 36 of the soiling detection apparatus 20 according to examples of the disclosure. In examples, the apparatus for programming the microcontroller 36 comprises a general purpose computer 66, an interface board 68 and the microcontroller 36 (a portion of the pin layout diagram of FIG. 6 for the microcontroller 36 is illustrated in the example of FIG. 7 for the ease of understanding the drawing). In examples, pins 6-11 of the microcontroller 36 are operably connected to the interface board 68 via a suitable cable and connectors. Power may be provided from the interface board 68 to the microcontroller 36 via pin 10 VCC and pin 11 GND. In examples, a program written in a suitable programming language may be loaded from the computer 66 to the microcontroller 36 via the interface board 68 so that the microcontroller can help provide functionality of the apparatus as described herein. In examples, the programming language is C++, although it will be appreciated that other suitable programming languages could be used and the other apparatus for programming the microcontroller may be used. In examples, the soiling detection circuitry comprises an interface port connectable to the interface board via a suitable connector mounted to the enclosure 32. Therefore, in examples, the operating conditions of the soiling detection apparatus may be changed or adapted as required, for example if different measurement time scales or durations are required. More generally, in examples, the microcontroller is externally programmable so as to control functionality of the soiling detection apparatus. This may help provide a more flexible measurement system for providing detection of soiling.

In examples, power is provided to the microcontroller 36 from the voltage regulator 40. FIG. 8 is a schematic circuit diagram of a voltage regulation circuit for providing electrical power to the microcontroller according to examples of the disclosure. In particular, in examples the voltage regulator 40 comprises a voltage regulating circuit as illustrated in FIG. 8.

In examples, the voltage regulating circuit comprises a voltage regulating integrated circuit 70, a battery 72, a first capacitor 74, and a second capacitor 76. In examples, the voltage regulating integrated circuit 70 is a positive voltage regulating integrated circuit (IC) model number LM7805 manufactured by STMicroelectronics®, with a pin layout as schematically illustrated in the example of FIG. 9. In examples, the battery is a 9 volt battery, for example a PP3 battery, the first capacitor 74 is a 10 μF electrolytic capacitor, and the second capacitor is a 0.10 g electrolytic capacitor connected as shown in FIG. 8. However, it will be appreciated that other suitable voltage regulating ICs, capacitors and batteries could be used. In other examples, the battery may be the battery 46 with suitable voltage regulation as appropriate. In examples, the voltage regulator circuit is operably connected to the microcontroller 36 via pin 10 VCC and pin 11 GND of the microcontroller 36 so as to be able to provide a 5 volt power supply.

FIG. 10 is a schematic diagram of a connection layout of a pyranometer and a shunt resistor used in the soiling detection apparatus according to examples of the disclosure. In particular, the example of FIG. 10 shows the shunt resistor 38, the pyranometer 24 and a portion of the microcontroller pin layout (for ease of understanding the drawing). In examples, so as to be able to measure an output voltage of the pyranometer 24, the pyranometer 24 is operably connected to a first analogue to digital converter (ADC) of the microcontroller 36 via pin 31 GND and pin 40 PA0 (ADC0). More generally in examples, the output voltage of the pyranometer 24 may be considered to be an irradiance signal which relates to an irradiance level of light incident on the pyranometer 24.

In examples, the shunt resistor 38 is operably connected to the microcontroller 36 so as to be able to be in electrical communication with the microcontroller 36. In examples, the shunt resistor is operably connected to a second analogue to digital converter (ADC) of the microcontroller 36 via pin 31 GND and pin 39 PAI (ADC1) so as to be able to measure the voltage across the shunt resistor 38. In examples, the shunt resistor 38 comprises a shunt resistor model SR10 by CADDOCK Electronics, with a 1 W rating and 0.008Ω resistance, and with a maximum operating current of 11 A. It also performs with substantially no rated load derating up to a temperature of 70 degrees centigrade, which may make it more suitable for use in arid and desert areas. In examples, the maximum short circuit current of the PV panel 22 (e.g. model FS-4115-3) is 1.83 A. Therefore, for example, the electrical output of the PV panel 22, such as the short circuit current of the PV panel 22, may be measured using the shunt resistor 38 and calculated via Ohm's law from the voltage input to the second ADC of the microcontroller 36. However, it will be appreciated that other shunt resistors and PV panels could be used and the electrical output of the PV panel 22 measured in other suitable ways, such as by an ammeter or voltmeter.

More generally in examples, the soiling detection apparatus comprises the shunt resistor 38 arranged to be connectable between output terminals of the photovoltaic panel 22, in which the measuring means (such as the microcontroller 36) is operable to measure the short circuit current by connection across the shunt resistor 38. In other words, in examples, the predetermined operating condition is a short circuit current of the photovoltaic panel 22. In other examples, the predetermined operating condition is a position on the current voltage curve of the PV panel 22 where the PV panel 22 is operable to output maximum power. However, this may vary with operating temperature of the PV panel 22 and may require more complex circuitry to set the predetermined operating condition. In examples, the short circuit current of the PV panel 22 is substantially directly proportional to solar irradiance, and variations in solar cell temperature are generally insignificant. For example, for the PV panel 22 (FS-4115-3) as used in examples of the disclosure, the short circuit current may change by by 0.04%/° C. in comparison with the short circuit current at standard test conditions at 25° C. In comparison, a maximum power output from the PV panel FS4113-3 of examples may change by 0.28%/° C. compared to standard test conditions at 25° C. In general, other photovoltaic panels and modules have a similar temperature dependent trend for short circuit current and maximum power. Therefore, for example, measurement of the short circuit current may provide a more accurate indication of the level of soiling, as well as helping to simplify circuitry needed to detect the soiling level.

In examples, the measured short circuit current of the PV panel 22 which relates to a soiling level of the panel 22 is compared with an expected short circuit current of the PV panel 22 as calculated from the output of the pyranometer 24 based on the irradiance signal. More generally, as mentioned above, in examples, the soiling detection apparatus is operable to compare the measured electrical output of the photovoltaic panel at the predetermined operating condition, such as the short circuit current of the PV panel 22, with the reference output value, for example from the pyranometer 24 so as to generate a comparison value. In examples, the comparison value may be used to determine whether a cleaning signal or other signal which relates to a soiling level may be output as will be described in more detail later below.

FIG. 11 is a schematic diagram of an output signal path from the microcontroller used in the soiling detection apparatus according to examples of the disclosure. In the example shown in FIG. 11, pin 1 PB0 (XCK/T0) and pin 11 GND of the microcontroller are operable to output a first logic signal, for example in dependence on a logic level of the microcontroller 36 based on the comparison value. In examples, the first logic signal is 0V or 5V although it will be appreciated that other suitable logic signals could be used. In examples, pins 1 and 11 of the microcontroller 36 may be operably connected to the second relay 50a so as to allow the first output signal 50a to be generated. In examples, the first output signal 50a is operable to be output when the comparison value is greater than the cleaning threshold value.

In examples, pin 2 PB1 (T1) and pin 11 GND of the microcontroller are operable to output a second logic signal, for example in dependence on a logic level of the microcontroller 36 based on the comparison value. In examples, the second logic signal is 0V or 5V although it will be appreciated that other suitable logic signals could be used. In examples, pins 2 and 11 of the microcontroller 36 may be operably connected to the third relay 52 so as to allow the second output signal 52a to be generated. In examples, the second output signal 52a is a warning signal which indicates that a cleaning event may be required soon for example. In examples, the warning signal is operable to be output when the comparison value is between a warning threshold value and the cleaning threshold value. In examples, the warning threshold value is lower than the cleaning threshold value. In other examples, the warning signal may be omitted and the third relay 52 not used.

In examples, pin 3 PB2 (AIN0/INT2) and pin 11 GND of the microcontroller are operable to output a third logic signal, for example in dependence on a logic level of the microcontroller 36 based on the comparison value. In examples, the third logic signal is 0V or 5V although it will be appreciated that other suitable logic signals could be used. In examples, pins 3 and 11 of the microcontroller 36 may be operably connected to the fourth relay 54 so as to allow the third output signal 54a to be generated. In examples, the third output signal 54a is operable to be output when the comparison value is less than or equal to the cleaning threshold value. In examples the third output signal 54a is a dormant signal, for example indicating that the photovoltaic panel does not need cleaning. In examples where a warning signal is implemented, the third output signal 54a is output when the comparison value is less than the cleaning threshold value and also less than the warning threshold value. Therefore, for example, the dormant signal may allow a PV plant operator to determine that a cleaning event does not need scheduling and so may help improve the efficiency of timing of cleaning events.

Although pins 1, 2, 3, and 11 have been described with reference to the first, second, and third output signals 50a, 52a and 54a respectively, it will be appreciated that other suitable pins of the microcontroller could be used. It will also be appreciated that the dormant signal, cleaning signal and warning signal may be generated in other suitable ways. Additionally, in examples, one or more of the first output signal 50a, second output signal 52a, and the third output signal 54a may be used to form a current path between the battery and a signal element such as a lamp or audio output element such as a loud speaker or piezoelectric buzzer via current path 57 with the battery 46.

FIG. 12 is a schematic circuit diagram of connection of the voltage regulation circuit to the light sensor 44 used in the soiling detection apparatus 20 according to examples of the disclosure. As mentioned above, in examples the soiling detection apparatus comprises a light sensor 44. In examples, the light sensor 44 is operable to detect an illumination level of light incident on the light sensor 44. In examples, the apparatus 20 is operable to perform detection of the soiling level when the illumination level is greater than a threshold illumination level. In examples, the light sensor 44 comprises light sensor switch, model AS-20 manufactured by Atoplee. In examples, the threshold illumination level may be such that the soiling detection is performed during the day, for example.

In examples, the soiling detection circuitry comprises the switch 56. In examples, the switch 56 is operably connected between the voltage regulator 40 and the light sensor 44, although it will be appreciated that other wiring configurations are possible. In examples, the switch 56 is operable to provide a manual override so that a soiling detection cycle may be performed on instigation by a user. In example, the switch 56 comprises a toggle switch such as an ST series toggle switch manufactured by Carling Technologies. However, it will be appreciated that any suitable type of switch could be used. In examples, the switch 56 allows manual activation or deactivation of the soiling detection measurement. In examples, as illustrated in FIG. 12, the voltage regulator 40 can be in electrical connection with the microcontroller 36 (for example to pin 10 VCC and pin 30 AVCC) via the light sensor 44 and the switch 56 so as to be able to provide power to the microcontroller 36. However, other suitable connection arrangements to be able to provide power to the microcontroller 36 could be used.

As mentioned above, in examples, the battery 46 is arranged to be able to provide power to the apparatus. In examples, the photovoltaic panel 22 can be in electrical connection with the battery 46 so as to be able to charge the battery 46. In examples, PV panel 22 is operably connected to the battery 46 via the charge controller 42 so to be able to charge the battery 46. In examples, the charge controller 42 is operable to control a charge stare of the battery 46, for example by controlling a charging rate from the PV panel 22 to the battery 46. In examples, the charge controller is a 12V-3A model Star03 manufactured by Lumiax, although it will be appreciated that other types of charge controller could be used. In examples, the soiling detection circuitry is operable to perform soiling detection in dependence on a soiling detection control signal, for example generated by the microcontroller. In examples, power may be provided to the microcontroller 36 from the battery 46, for example by using a suitable voltage regulation circuit. However, in other examples, the microcontroller may be supplied from any other suitable power source, such as a 9V battery, or regulated mains power. However, the use of one or more batteries may allow the apparatus 20 to operate in remote locations without external supporting infrastructure.

In examples, the PV panel 22 is operable to charge the battery 46 when soiling detection is not performed. In examples, a soiling detection cycle is performed at substantially regular intervals as described in more detail later below. In other words, more generally in examples, the apparatus 20 is operable to measure the electrical output of the photovoltaic panel at predetermined time intervals so as to detect a soiling level of the PV panel 22. In examples, the apparatus 20 is operable to measure the electrical output of the photovoltaic panel 22 for a predetermined duration.

As mentioned above, in examples, the soiling detection circuitry comprises a first relay 48 which is operably connected to the pyranometer 24, the microcontroller 36, the PV panel 22 and the charge controller 42. In examples, the first relay 48 is a double pole, double throw (DPDT) relay such as a 5V, 8 pin relay, model number JW2SN-DC5V manufactured by Panasonic. However, it will be appreciated that other types of relay could be used. In examples, the first relay 48 comprises a coil comprising a pair of coil terminals, a first set of relay contacts and a second set of relay contacts. In examples, the first set of relay contacts comprises a first common terminal, a first normally open terminal and a first normally closed terminal, in which current may flow between the first common terminal and the first open terminal or first normally closed terminal depending on whether coil is energised (current flowing through the coil). In examples, the second set of relay contacts comprises a second common terminal, a second normally open terminal, and a second normally closed terminal, in which current may flow between the second common terminal and the second open terminal or second normally closed terminal depending on whether coil is activated (current flowing through the coil). In other words, for example, the first relay 48 may operate as a double pole double throw type relay.

In examples, the microcontroller 36 is operably connected to the coil so as to be able to energise the coil so as to be able to switch the first relay 48. In examples, the soiling detection control signal comprises a relay control signal In examples, the coil terminals are operably connected to pin 11 GND and pin 4 PB3 (AIN1/OC0) so that the coil may be energised by the relay control signal such as a 5V output signal from the microcontroller 36, for example so as to allow the soiling detection apparatus to perform soiling detection or control soiling detection measurement.

In examples, the first common terminal is electrically connected to an electrical terminal of the PV panel 22, and the shunt resistor 38 is electrically connected to the first normally open terminal so that current may flow through the shunt resistor 38 when the coil is energised, for example in response to the relay control signal output by the microcontroller. In examples, the pyranometer 24 is operably connected to pin 40 and pin 31 of the microcontroller 36 as indicated in the example of FIG. 10 via the second common terminal and the second normally open terminal so that the pyranometer 24 may be in electrical connection with the microcontroller 36 when the coil of the first relay 48 is energised, for example in response to the relay control signal of the microcontroller 36. In examples, the first normally closed terminal is operably connected to the charge controller 42 so that the battery 46 may be charged when the coil is not energised, for example when soiling detection is not being performed. In examples, the second normally closed terminal is not connected. In other words, in examples, the soiling detection circuitry is operable to perform soiling detection in dependence upon the relay control signal.

In other examples, the pyranometer 24 and the shunt resistor 38 could be operably connected to normally closed terminal of the relay 48, and the charge controller 42 connected to a normally open terminal so as to be able to charge the battery 46 when the coil is energised. However, it will be appreciated that other connection arrangements could be used.

In other examples, the connection to the charge controller 42 may be omitted and other arrangements used to charge the battery 46. Additionally, it will be appreciated that the battery 46 could be omitted with appropriate modifications for the output signals from the microcontroller 36 such as output signals 50a, 52a, and 54a.

Examples of methods for operating the soiling detection apparatus will now be described with reference to FIGS. 13, 14A and 14B. FIG. 13 is a flow chart of a method for detecting a soiling level of a photovoltaic panel using a soiling detection apparatus according to examples of the disclosure. In examples, a soiling detection method for detecting a soiling level of a photovoltaic panel is performed using the soiling detection apparatus 20. As mentioned above, in examples, the soiling detection comprises the photovoltaic panel 22 and the pyranometer 24 which is positioned with respect to the photovoltaic panel 22 such that the photovoltaic panel 22 and the pyranometer 24 can receive substantially the same solar radiation level as each other.

At a step s100, an electrical output is generated by the PV panel 22 in response to light being incident on the panel and in dependence upon a soiling level of the photovoltaic panel 22. In examples, the electrical output is a photovoltaic current which may for example be measurable by the shunt resistor 38. However, in other examples, the electrical output could be the power generated by the PV panel, for example as determined from a measured output voltage and measured output current using the equation power=voltage×current. However, it will be appreciated that other techniques to measure the current, voltage, power of other forms of electrical output of the PV panel 22 may be used.

In a step s102, the pyranometer 24 generates an irradiance signal which relates to an irradiance level of light incident on the pyranometer 24. For example, the irradiance signal may relate to a level of solar radiation incident on the pyranometer 24.

At a step s104, a reference output value is calculated from the irradiance signal, for example by the microcontroller 36, although other techniques could be used. In examples, the reference output value relates to an ideal electrical output of the photovoltaic panel 22 at a predetermined operating condition. In examples, the predetermined operating condition is a short circuit current of the PV panel 22. In examples, the ideal electrical output is a short circuit current of the PV panel 22 that would be expected to be obtained for the PV panel 22 when the PV panel is in a substantially clean state (e.g. substantially no soiling). However, it will be appreciated that other predetermined operating conditions could be used such as a biasing position of the PV panel 22 where maximum power of the PV panel may be obtained. As mentioned above, using the short circuit current as the predetermined operating condition may help reduce circuit complexity and help reduce temperature dependence of the reference output value.

At a step s106, the electrical output of the photovoltaic panel 22 at the predetermined operating condition is measured, for example by an ADC of the microcontroller 36 by measuring the voltage across the shunt resistor 38. However, it will be appreciated that other techniques for measuring the electrical output of the PV panel at the predetermined operating condition could be used, for example, if maximum power is to be measured.

At a step s108, the measured electrical output of the photovoltaic panel 22 at the predetermined operating condition is compared with the reference output value so as to generate a comparison value. In examples, the microcontroller 36 is operable to compare the measured electrical output with the reference output value so as to generate the comparison value. However, it will be appreciated that other appropriate arrangements could be used, such as a comparator circuit.

At a step s110, it is determined whether the comparison value is greater than a cleaning threshold value. In examples, the microcontroller 36 is operable to determine whether the comparison value is greater than the cleaning threshold value, although it will be appreciated that other techniques and circuitry or apparatus could be used. In examples, the cleaning threshold value may be set by programming the microcontroller appropriately, for example, using the apparatus described above with reference to FIG. 7.

If the comparison value is greater than the cleaning threshold value, then the cleaning output signal is output at a step s112, for example corresponding output signal 50a. In other words, for example, the cleaning signal is output when the comparison value is greater than a cleaning threshold value. For example, the cleaning signal may indicate that the photovoltaic panel needs cleaning. If however, the comparison value is less than the cleaning comparison value, or less than or equal to the comparison, then, at a step s114, a dormant signal is output, for example corresponding to output signal 54a. As mentioned above, in some examples, a warning signal may also be output when appropriate, as described in more detail below with reference to FIGS. 14A and 14B.

FIGS. 14A and 14B are a flowchart of a method for detecting a soiling level of the photovoltaic panel 22 by measuring the voltage across the shunt resistor 38 according to examples of the disclosure. The flow charts of FIG. 14A and FIG. 14B should be considered together as part of the same procedural flow chart for measuring a soiling level of the PV panel 22 of examples of the disclosure. However, two drawing sheets have been used to illustrate the flow chart for ease of understanding, clarity, and space. In FIGS. 14A and 14B, circled letters A, B, and C indicate where the flow chart joins between pages with like letters linking like flow. For example, circled A in FIG. 14B links to circled A in FIG. 14A. In the example of FIGS. 14A and 14B the method is performed under control of the microprocessor 36, although it will be appreciated that other ways of implementing the method may be used.

At a step s200, it is determined whether an auto light switch sensor is on. In examples, the auto light switch sensor comprises the light sensor 44. For example, if an illumination level of light incident on the light sensor 44 is greater than the threshold illumination then the auto light switch sensor is determined to be on. For example, the threshold illumination level may correspond to a minimum level of illumination typically found during the daytime at a site where the apparatus 20 is located. In other words, for example, the soiling detection may be arranged to be performed during the day and not at night.

If, for example, the auto light switch sensor is determined to be off, for example because the light incident on the light sensor 44 is less than the threshold illumination level, then a wait period is started at a step s202. After the end of the wait period, the procedure passes to the step s200. In examples, whether method step s202 passes to the step s200 depends on a switch status of the switch 56. For example, step s202 may proceed to the step s200 if the switch 56 is closed. However, if the switch 56 is open for example, then processing halts and method step S202 does not proceed to the step s200, for example due to manual override of the soiling detection measurement by an operator using the switch. In other examples, the switch 56 may be used to bypass the auto light switch sensor so that steps s200 and s202 are not performed. This may occur if an operator wishes to manually override when a soiling detection measurement occurs such that it can be performed when bypass of the light sensor 44 occurs, for example.

In examples, the wait period may correspond to a predetermined time period such as 10 minute, 20 minutes, 30 minutes and the like, although any time period could be used. In other examples, the wait period is less than 10 seconds so that a soiling detection measurement may be performed in a timely manner when the threshold illumination level is exceeded for example.

If, for example, the auto light switch sensor is determined to be on at the step s200, then, at a step s204, a first time parameter T1 is set. In examples T1 is an integer in the range 1≤T1≤30 where T1 is measured in minutes (e.g. T1=1→30 min). T1 is initially set at T1=1 but may be subsequently iteratively increased by making T1=T1′, where the value of T1′ is defined below in an incrementing step (step s238) as described later.

At a step s206, a second time parameter T2 is set. In examples, T2 is an integer in the range 10≤T2≤60 where T2 is measured in seconds (e.g. T2=10→60 sec). T2 is initially set at T2=10 but may be subsequently iteratively increased by making T2=T2′, where the value of T2′ is defined below in an incrementing step (step s232) as described later.

At a step s208, a third time parameter T3 is set. In examples, T3 is an integer in the range 1≤T2≤10 where T3 is measured in seconds (e.g. T3=1→10 sec). T3 is initially set at T3=1 but may be subsequently iteratively increased by making T3=T3′, where the value of T3′ is defined below in an incrementing step (step s226) as described later.

One or more of the steps s204, s206, and s208 may be performed in the order in which they are described, or two or more of these steps may be performed in parallel. Additionally, it will be appreciated that one or more of T1, T1′, T2, T2′, T3 and T3′ could be any other number (for example an integer, real, complex, rational, or irrational number), and that other ranges for their values could be used. It will also be appreciated that different initialisation values other than those mentioned above could be set.

At a step s210, an analogue voltage of the shunt resistor 38 is measured so as to generate a first analogue signal, for example by input to a first analogue to digital converter (ADC) of the microcontroller 36. In other words, for example, an analogue voltage across the shunt resistor 38 may be measured to determine a current through the shunt resistor 38.

At a step s212, the first analogue signal is converted into a first digital signal by the first ADC of the microcontroller 36.

At a step s214, the microcontroller 36 may multiply the first digital signal by a shunt resistor factor so as to calculate a short circuit current value (a) of the PV panel 22 for example that relates to a soiling level of the PV panel. For example, the short circuit current value may be calculated from the measured voltage across the shunt resistor 38 using Ohm's law. In examples, the shunt resistor 38 resistance is 0.008 Ohms, although other suitable values could be used.

At a step s216, an analogue voltage of the pyranometer 24 is measured so as to generate a second analogue signal, for example by input to a second analogue to digital converter (ADC) of the microcontroller 36. In other words, for example, an analogue voltage generated by the pyranometer 24 may be measured to determine an irradiance level of the pyranometer 24.

At a step s218, the second analogue signal is converted into a second digital signal by the second ADC of the microcontroller 36.

At a step s220, the microcontroller 36 may multiply the second digital signal by a pyranometer factor so as to calculate a solar irradiance value of light incident on the pyranometer 24. In other examples, the microcontroller 36 may determine the solar irradiance value via a lookup table (LUT) stored in the microcontroller 36 or in external memory that, for example, relates the irradiance value to the pyranometer output voltage. However, it will be appreciated that other suitable techniques for determining the irradiance level from the pyranometer 24 output maybe used.

At a step s222, an expected short circuit current (b) associated with the PV panel 22 in a clean state is calculated by the microcontroller 36 from the irradiance value obtained from the pyranometer 24. In examples, the short circuit current of the PV panel 22 is substantially proportional to the irradiance of light incident on the PV panel. Therefore, the irradiance value obtained from the pyranometer 24 may allow an indication of what the measured short circuit current would be expected to be for the PV panel 22 in a clean state. However, other techniques for obtaining the expected short circuit current (b) for a clean panel may be used, such as via a look up table, or other known relationship.

In examples, the steps S210, s212, and s214 are performed in parallel with the steps s216, s218, s220, and s222. However, it will be appreciated that other orders of performance between the steps such as a combination of sequential and parallel or sequential performance could be used.

At a step s224, the microcontroller determined if the value of T3=10 seconds. If not, then at a step s226, the value of T3 is increased by 1 so as to generate an incremented value T3′=T3+1. In examples, the value of the short circuit current (a) and the expected short circuit current (b) measured at the step s210 to s222 are stored in the memory of the microcontroller 36 at the step s224 so as to generate a plurality of stored current values. Processing then proceeds from the step s226 to the step s208. In other words, more generally, in examples, measurement of the short circuit current (a) of the PV panel 22 and the expected short circuit current (b) as obtained from the pyranometer 24 occurs at a first predetermined frequency. In the example of FIGS. 14A and 14B, the first predetermined frequency is such that measurement of the short circuit current (a) of the PV panel 22 and the expected short circuit current (b) occurs every 1 seconds, although it will be appreciated that other time periods could be used.

If T3=10 seconds, then processing proceeds to the step s228. At the step s228, the microcontroller 36 calculates a mean average of the measured short circuit current values (a) and the expected short circuit current values (b) from the plurality of stored current values stored in the memory at the step s224 so as to generate a mean measured short circuit current value {a} and a mean expected short circuit current value {b}. In other words, more generally, in examples, calculation of the mean measured short circuit current values and the mean expected short circuit current values occurs at a second predetermined frequency. In the example of FIGS. 14A and 14B, the second predetermined frequency is such that calculation of the mean values {a} and {b} occurs every 10 seconds, although it will be appreciated that other time periods could be used.

At a step s230, the microcontroller determines if the value of T2=60 seconds. If not, then at a step s232, the value of T2 is increased by 10 so as to generate an incremented value T2′=T2+10. In examples, the mean short circuit current value {a} and the mean expected short circuit current value {b} calculated at the step s228 are stored in the memory of the microcontroller 36 at the step s230 so as to generate a plurality of stored mean values. Processing then proceeds from the step s232 to the step s206.

If T2=60 seconds, then processing proceeds to step s234. At the step s234 the microcontroller 36 calculates respective ampere hour (AH) values from the plurality of stored mean values for {a} and {b} based on the elapsed time and the stored mean values. The microcontroller then sums the respective ampere hour values to generate summed ampere hour (AH) values [a] and [b]. In other words, more generally, in examples, calculation and summation of the summed ampere hour values occurs at a third predetermined frequency. In the example of FIGS. 14A and 14B, the third predetermined frequency is such that the calculation and summation of the summed ampere hour values [a] and [b] occurs every 60 seconds (each minute), although it will be appreciated that other time periods could be used.

At a step s236, the microcontroller determines if the value of T1=60 minutes. If not, then at a step s238, the value of T1 is increased by 1 so as to generate an incremented value T1′=T+1. In examples, the summed ampere hour values [a] and [b] calculated at the step s234 are stored in the memory of the microcontroller 36 at the step s236 so as to generate a plurality of stored ampere hour values. Processing then proceeds from the step s238 to the step s204. The use of ampere hour calculations and/or calculation of mean averages may help reduce the likelihood of a false signal being output, for example due to an instantaneous short circuit current measurement exceeding a threshold.

If T1=30 minutes, then processing proceeds to step s240. At the step s240 the microcontroller 36 sums the stored ampere hour values that were stored in the memory at the step s236 so as to generate total summed ampere hour (AH) values [a′] and [b′]. In other words, more generally, in examples, summation of the store ampere hour values occurs after a predetermined soiling measurement time period. In the example of FIGS. 14A and 14B the predetermined soiling measurement time period is 30 minutes although it will be appreciated that other time periods could be used. In other words, in examples, it takes substantially 30 minutes for a full soiling detection cycle to be carried.

At a step s242, the ratio [b′]/[a′] is calculated by the microcontroller 36. In examples, the ratio [b′]/[a′] may be considered to be a comparison value such as that mentioned above with reference to FIG. 13 and the foregoing description.

At a step s244, the microcontroller 36 determines if the ratio [b′]/[a′] is between a first threshold and a second threshold. In words, for example, the microcontroller determines if first threshold<[b′]/[a′]<second threshold. In examples, the first threshold corresponds to the warning threshold mentioned above, and second threshold corresponds to the cleaning threshold mentioned above.

If the ratio [b′]/[a′] is between the first threshold (warning threshold) and the second threshold (cleaning threshold), then at a step s246, the warning signal is output and other output signals are stopped. However, in other examples, the step of stopping other output signals at step s246 may be omitted.

If the ratio [b′]/[a′] is not between the first threshold and the second threshold, then at a step s248, the microcontroller determines if the ratio [b′]/[a′] is greater than the second threshold (cleaning threshold).

If the ratio [b′]/[a′] is greater than the second threshold (cleaning threshold), then at a step s250 the cleaning signal is output, and other signals are stopped. However, in other examples, the step of stopping other output signals at s250 may be omitted.

If the ratio [b′]/[a′] is not greater than the second threshold (cleaning threshold), then at a step s252 the dormant signal is output.

At a step s254, the signal that was output at the step s246, s250 or s252 is kept active (continued to be output). In other words, for example, processing may proceed from the step s246 to the step s254, from the step s250 to the step s254, and from the step s252 to the step s254. This may allow a plant operator to easily see a soiling state of the PV panel even if the soiling detection cycle is not currently running In examples, the soiling detection procedure (soiling detection cycle) may be performed at a predetermined soiling cycle measurement interval. The use of the predetermined soiling cycle measurement interval may help save energy because the soiling detection is not continuous. Furthermore, memory requirements of the microprocessor may be reduced which may help reduce costs. In examples, the soiling cycle measurement interval is 2 hours, although it will be appreciated that other time intervals could be used. Once the soiling cycle measurement interval has elapsed, then processing proceeds to the step s200.

It will be appreciated that while the steps of FIGS. 13, 14A and 14B have been described substantially sequentially, they need not be performed in that order and other orders of performing the steps are possible. It will also be appreciated that one or more of the steps could be performed sequentially and/or in parallel to each other, or some steps omitted, such as the steps s234, s236, s238, and s204. It will be appreciated that the time periods relevant to the method described in FIGS. 14A and 14B such as the first, second and third predetermined frequencies, the predetermined soiling measurement time period and the soiling cycle measurement interval may be varied or set for example by programming of the microcontroller 36. For examples, the soiling cycle measurement interval may be varied in dependence on the season. Additionally, if for example, the weather is predicted to be cloudy, it may be preferable to measure the soiling level over a shorter duration for example as determined by the soiling measurement time period so as to try to ensure a more consistent measurement over the measurement period.

Additionally, it will be appreciated that the first threshold (warning threshold) and second threshold (cleaning threshold) may be varied depending on operating requirements.

In examples, the apparatus 20 comprises a communication module operable to allow the microcontroller 36 to communicate with an external network or apparatus such as a PV plant control network via a suitable communication interface such as wifi, ethernet, wireless cellular network and the like. In examples, the microcontroller is operable to be programmable, for example via the communication module, to set one or more of the first threshold, the second threshold, the timing of soiling detection measurements, and increment steps and ranges of T1, T2, and T3. This may, for example, allow the apparatus 20 to be programmed remotely as appropriate for the operating conditions of its location. Additionally, in examples, the apparatus 20 is operable to output one of more of the output signals, such as the dormant signal, warning signal and cleaning signal via the communication module to a remote location such as a PV plant control room. The apparatus 20 may thus, for example, be operated remotely if desired.

In examples, the apparatus is operable to generate a rating signal in dependence upon the comparison value. In examples, the rating signal relates to a predicted output of one or more other photovoltaic panels having substantially the same soiling level as the photovoltaic panel of the apparatus. In examples, the microcontroller 36 is operable to output the rating signal, for example via the communication module. For example, if the soiling detection apparatus 20 is positioned so as to be able to receive substantially the same soiling level as one or more PV panel of a PV plane, the rating signal may be used by a PV plant operator to determine an expected electrical output of the PV plant.

For example, the ratio [b′]/[a′] calculated as mentioned above at the step s242 may be used to indicate or predict an expected electrical output of a second PV panel (or plurality of other PV panels) having substantially the same level of soiling as the PV panel 22 such that an expected performance level of the second panel or plurality of panels is proportional to the ratio [b′]/[a′] in comparison with the expected output for the second PV panel (or plurality of panels) when there is substantially no soiling. In other words, in examples, the apparatus 20 is operable to rate a soiling impact on the output of photovoltaic panels based on the comparison value and the measured short circuit current. This may help a PV plant operator be able to predict power output from the plant more accurately and so may help with power grid management, power distribution, and profit prediction.

It will be appreciated that where a photovoltaic panel or panels is mentioned, one or more PV modules may be used instead of or in combination with one or more PV panels. It will also be appreciated that a PV panel (or PV panels) could comprise one or more PV modules as appropriate. It will also be appreciated that the PV panel(s) of examples of the disclosure could have any appropriate physical configuration, such as having a substantially planar light receiving surface, or a curved light receiving surface for example.

The apparatus and method of examples of the disclosure may allow for easy integration with existing PV plants as well as being able to be used as a standalone unit, for example to determine if a site is suitable for a PV plant. Additionally, different types of PV panel may be used as the reference PV panel (such as PV panel 22), with the microcontroller 36 programmed as appropriate. In other words, for examples, the apparatus and method of the disclosure may help provide a more flexible and easily adapted way of determining a soiling level of a PV panel.

Although a variety of examples have been described herein, these are provided by way of example only and many variations and modifications on such examples will be apparent to the skilled person and fall within the spirit and scope of the present invention, which is defined by the appended claims and their equivalents.

1. A soiling detection apparatus operable to detect a soiling level of a photovoltaic panel, the apparatus comprising:
a photovoltaic panel operable to generate an electrical output in response to light being incident on the panel and in dependence upon a soiling level of the photovoltaic panel;
a pyranometer operable to generate an irradiance signal which relates to an irradiance level of light incident on the pyranometer, the pyranometer being positioned with respect to the photovoltaic panel such that the photovoltaic panel and the pyranometer can receive substantially the same solar radiation level as each other;
calculating means operable to calculate a reference output value from the irradiance signal which relates to an ideal electrical output of the photovoltaic panel at a predetermined operating condition;
measuring means operable to measure the electrical output of the photovoltaic panel at the predetermined operating condition;
comparing means operable to compare the measured electrical output of the photovoltaic panel at the predetermined operating condition with the reference output value so as to generate a comparison value; and
outputting means operable to output a cleaning signal when the comparison value is greater than a cleaning threshold value.

2. A soiling detection apparatus according to claim 1, in which the outputting means is operable to output a dormant signal when the comparison value is less than or equal to the cleaning threshold value.

3. A soiling detection apparatus according to claim 1, in which the outputting means is operable to output a warning signal when the comparison value is between a warning threshold value and the cleaning threshold value.

4. A soiling detection apparatus according to claim 1, in which the predetermined operating condition is a short circuit current of the photovoltaic panel.

5. A soiling detection apparatus according to claim 4, comprising a shunt resistor arranged to be connectable between output terminals of the photovoltaic panel, in which the measuring means is operable to measure the short circuit current by connection across the shunt resistor.

6. A soiling detection apparatus according to claim 1, comprising a battery arranged to be able to provide power to the apparatus, in which the photovoltaic panel can be in electrical connection with the battery so as to be able to charge the battery.

7. A soiling detection apparatus according to claim 1, comprising a light sensor operable to detect an illumination level of light incident on the light sensor, in which the apparatus is operable to perform detection of the soiling level when the illumination level is greater a threshold illumination level.

8. A soiling detection apparatus according to claim 7, in which the photovoltaic panel is operable to charge a battery when soiling detection is not performed.

9. A soiling detection apparatus according to claim 1, in which the apparatus is operable to measure the electrical output of the photovoltaic panel at predetermined time intervals so as to detect a soiling level of the photovoltaic panel.

10. A soiling detection apparatus according to claim 1, in which the apparatus is operable to measure the electrical output of the photovoltaic panel for a predetermined duration.

11. A soiling detection apparatus according to claim 1, in which the photovoltaic panel comprises a plurality of thin film photovoltaic cells.

12. A soiling detection apparatus according to claim 1, in which:
the apparatus is operable to generate a rating signal in dependence upon the comparison value; and
the rating signal relates to a predicted output of one or more other photovoltaic panels having substantially the same soiling level as the photovoltaic panel of the apparatus.

13. A photovoltaic plant comprising a plurality of photovoltaic panels for generating electricity, the photovoltaic plant comprising a soiling detection apparatus according to claim 1, in which the soiling detection apparatus is positioned with respect to one or more photovoltaic panels of the photovoltaic plant so as to receive substantially the same soiling as the one or more photovoltaic panels of the photovoltaic plant.

14. A soiling detection method for detecting a soiling level of a photovoltaic panel using a soiling detection apparatus comprising a photovoltaic panel and a pyranometer positioned with respect to the photovoltaic panel such that the photovoltaic panel and the pyranometer can receive substantially the same solar radiation level as each other, the method comprising:
generating, by the photovoltaic panel, an electrical output in response to light being incident on the panel and in dependence upon a soiling level of the photovoltaic panel;
generating, by the pyranometer, an irradiance signal which relates to an irradiance level of light incident on the pyranometer;
calculating a reference output value from the irradiance signal which relates to an ideal electrical output of the photovoltaic panel at a predetermined operating condition;
measuring the electrical output of the photovoltaic panel at the predetermined operating condition;
comparing the measured electrical output of the photovoltaic panel at the predetermined operating condition with the reference output value so as to generate a comparison value; and
outputting a cleaning signal when the comparison value is greater than a cleaning threshold value.
